(19) United States
(12) Patent Application Publication
(10) Pub. No.: US 2013/0119135 A1
(43) Pub. Date: May 16, 2013

(54) BI-DIRECTIONAL AND MULTI-FREQUENCY RF SIGNALING SYSTEM

(71) Applicants: Jules Gauthier, Laval (CA); Anthony Ghiotto, Talence (FR); Ke Wu, Montreal (CA)

(72) Inventors: Jules Gauthier, Laval (CA); Anthony Ghiotto, Talence (FR); Ke Wu, Montreal (CA)

(73) Assignee: POLYVALOR, LIMITED PARTNERSHIP, Montreal, QC (CA)

(21) Appl. No.: 13/811,838

(22) PCT Filed: Jul. 26, 2011
(86) PCT No.: PCT/CA11/50461

§ 371 Date: Jan. 23, 2013

Related U.S. Application Data
(60) Provisional application No. 61/367,658, filed on Jul. 26, 2010.

(51) Int. Cl. G06K 19/07; G06K 7/10

(52) U.S. Cl. CPC G06K 19/0724; G06K 7/10356
USPC 235/439; 235/492

(57) ABSTRACT

There is described herein an active bidirectional tag for use in an RF signaling system for real-time and non-real time localization. The tag has a first antenna that operates at a first frequency and a second antenna that operates at a second frequency. The two antennas allow the tag to perform more than one function concurrently, and to provide different ranges of communication between the two antennas. The tag is low cost, low power, and multi-use.

### CROSS-REFERENCE TO RELATED APPLICATIONS

This application claims priority under 35 U.S.C. §119(e) from U.S. Provisional Patent Application No. 61/367,658, filed on Jul. 26, 2010, the contents of which are hereby incorporated by reference.

### TECHNICAL FIELD

The present invention relates to the field of Radio Frequency signaling systems, such as RFID and other similar platforms used for electronic tolls, access control in industrial and residential environments, wireless sensors, tracking in closed spaces inaccessible by Global Positioning Systems (GPS), and other applications.

### BACKGROUND OF THE ART

RFID is a data collection technology that uses electronic tags for storing data. The tag is made up of an RFID chip attached to an antenna, and can transmit in the kilohertz, megahertz and/or gigahertz range. RFID systems have been around for many years and are used for a variety of applications. The tags (or systems) may be classified in three broad categories, namely active, passive, and semi-passive (or semi-active).

Passive tags have no power source but use the electromagnetic waves from a reader to energize the chip and transmit back their data. Passive tags can cost less than a 25 cents and be read up to approximately 30 feet from the reader's antenna. Active tags have a battery that can transmit up to 300 feet indoors and more than a thousand feet outdoors. Used for tracking trailers in yards and containers on the loading dock, active tags cost several dollars and may periodically transmit a signal for readers to pick up or may lie dormant until they sense the reader's signal.

Semi-passive tags combine passive backscattering with a battery that allows the device to beep, blink or perform some operation. For example, a semi-passive tag on refrigerated cartons can include a sensor that, when interrogated, reports the temperature range during shipment. The advantage of a semi-passive tag is that it increases the range available with a passive tag, without reaching the costs of an active tag.

However, semi-passive tags are not currently exploited to their full potential, particularly in applications like electronic tolls and non-GPS tracking. This is mainly due to the lack of performance of existing solutions, despite being cheaper than active tags.

Therefore, there is a need for an improved RFID system that uses active and/or semi-passive tags in a low power, low cost, multi-use manner.

### SUMMARY

There is described herein an active bidirectional tag for use in an RF signaling system for real-time and non-real time localization. The tag has a first antenna that operates at a first frequency and a second antenna that operates at a second frequency. The two antennas allow the tag to perform more than one function concurrently, and to provide different ranges of communication between the two antennas. The tag is low cost, low power, and multi-use.

In accordance with a first broad aspect, there is provided an active bidirectional tag for use with a base station in a Radio Frequency (RF) signaling system, the tag comprising: at least a first antenna for receiving a detection signal emitted from the base station at a first frequency; a control circuit for storing identification data and providing the identification data on an information signal when activated by the detection signal; and at least a second antenna adapted for transmitting the information signal at a second frequency to the base station.

In accordance with a second broad aspect, there is provided an active, bidirectional tag for use in a Radio Frequency (RF) signaling system, the tag comprising: at least a first antenna for receiving a detection signal from a base station at a first frequency; a control circuit for storing identification data and, once activated by the detection signal, providing the identification data on an identification signal; and at least a second antenna for transmitting at least the identification signal at a second frequency different from the first frequency.

There is also provided an RF signaling system comprising the active bi-directional tag and a base station. The base station comprises at least a third antenna and a fourth antenna, the third antenna adapted for transmission of the detection signal at the first frequency and reception of a reflection of the detection signal at the first frequency, the fourth antenna adapted for reception of the information signal at the second frequency.

In accordance with another broad aspect, there is provided an RF signaling system comprising: a base station having at least a first antenna and a second antenna, the first antenna adapted for transmission of a detection signal at a first frequency and reception of a reflection of the detection signal at the first frequency, the second antenna adapted for reception of an information signal at a second frequency; and an active, bidirectional tag having at least a third antenna and a fourth antenna, the third antenna adapted for receiving the detection signal at the first frequency, the fourth antenna adapted for transmitting the information signal at the second frequency.

There is also described herein a substrate for use in a variety of circuits, such as filters, oscillators, resonators, and antennas, and any radio frequency application having transmission lines. The substrate is composed of at least two layers, one of the at least two layers having a positive thermal coefficient of a dielectric constant and another of the at least two layers having a negative thermal coefficient of a dielectric constant. In one embodiment, the at least two layers are superposed on top of each other. In one embodiment, a relative thickness of the at least two layers results in a cancellation of thermal variation effects of the substrate. In another embodiment, a combination of the positive thermal coefficient of a dielectric constant and the negative thermal coefficient of a dielectric constant results in a cancellation of thermal variation effects of the substrate. In addition, at least one of the at least two layers may be composed of at least two materials.

The substrate may be used to correct various types of thermal effects, such as compensating for frequency deviations as a function of time for an active component. The present description should not be considered as being limited to any one type of thermal effect.

While the present description uses 2.45 GHz as the first frequency and 5.8 GHZ as the second frequency, it should be understood that other frequencies may be used. In addition, the second frequency may be lower than the first frequency, depending on the application.

The expression “signaling system” should be understood to mean a system that can be used for sensing, identification, tracking, positioning, and/or communication.

### BRIEF DESCRIPTION OF THE DRAWINGS

Further features and advantages of the present invention will become apparent from the following detailed description, taken in combination with the appended drawings, in which:

FIG. 1 is a schematic of an exemplary RF signaling system including a base station and a tag, in accordance with one embodiment;

FIG. 2 is a block diagram of an exemplary base station;

FIG. 3 is an exemplary circuit diagram of the detector of FIG. 2;

FIG. 4 is an exemplary three patch network antenna for one of the antennas of the base station;

FIG. 5 illustrates an exemplary radiation pattern for the antenna of FIG. 4;

FIG. 6 is an exemplary circuit diagram of the receiver of FIG. 2;

FIG. 7 is an exemplary four patch network antenna for the other one of the antennas of the base station;

FIG. 8 illustrates an exemplary radiation pattern for the antenna of FIG. 7;

FIG. 9 illustrates an exemplary 16 element antenna with a scanning mechanism;

FIG. 10 illustrates an exemplary circuit diagram for the tag of FIG. 1;

FIG. 11 is a perspective view of an exemplary resonator for the tag and/or base station;

FIG. 12 is a graph showing the temperature response for two exemplary oscillators made on two different substrates one having a positive and the other a negative dielectric thermal coefficient;

FIG. 13 is a graph showing an effective temperature response for an exemplary oscillator made on a substrate in accordance with one embodiment;

FIG. 14 is an exemplary generic circuit diagram of an oscillator;

FIG. 15a is an exemplary circuit diagram of an oscillator;

FIG. 15b is an exemplary circuit layout of the oscillator of FIG. 15a;

FIG. 16a illustrates a Microstrip transmission line made of two substrates for compensation of thermal effects;

FIG. 16b illustrates a Microstrip transmission line with a superstrate for compensation of thermal effects;

FIG. 16c illustrates a Coplanar Waveguide transmission line with a superstrate for compensation of thermal effects;

FIG. 16d illustrates a Grounded Coplanar Waveguide transmission line made of two substrates for compensation of thermal effects;

FIG. 16e illustrates a Grounded Coplanar Waveguide transmission line with a superstrate for compensation of thermal effects;

FIG. 16f illustrates a Slotline transmission line with a superstrate for compensation of thermal effects;

FIG. 16g illustrates a Stripline transmission line made of two substrates for compensation of thermal effects;

FIG. 16h illustrates a Dielectric Loaded Waveguide transmission line made of two substrates for compensation of thermal effects; and

FIG. 16i illustrates a Substrate Integrated Waveguide transmission line made of two substrates for compensation of thermal effects.

It will be noted that throughout the appended drawings, like features are identified by like reference numerals.

### DETAILED DESCRIPTION

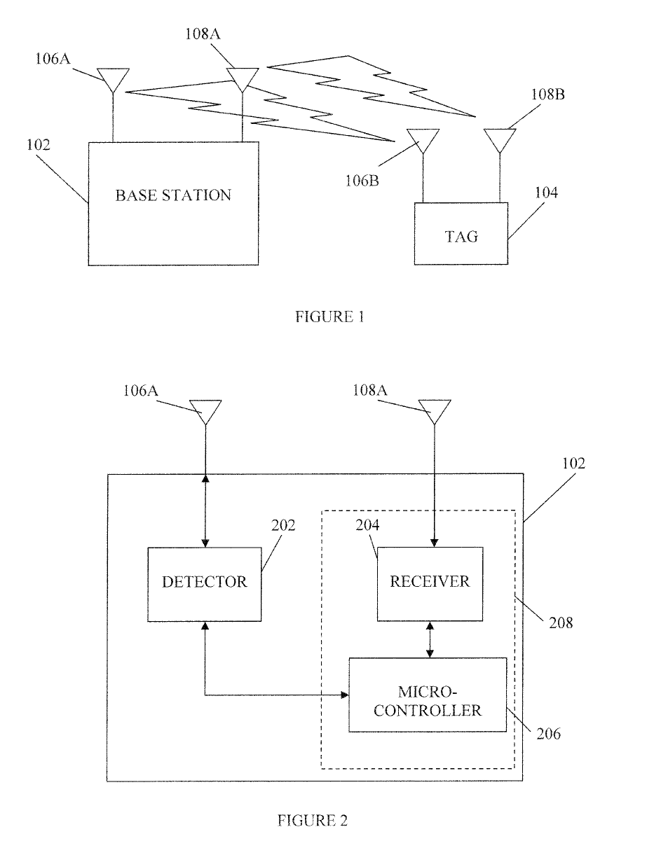

There is described herein a multi-use RF signaling system for detection and/or identification, in real-time, pseudo-real-time, and non-real-time. The system, as illustrated in FIG. 1, comprises two components, namely a base station 102 and a tag 104. The base station 102 may transmit commands to the tag 104 to activate it and/or to set the tag 104 in a variety of modes. The base station 102 may also receive information from the tag 104.

The RF signaling system may be used for a variety of applications, such as security, tracking, managing of resources, and improving processes. For example, the system may be used in a prison to track the displacements of prisoners, or outside of the prison to track conditionally-released individual. It may also be used in warehouses or yards to manage the various resources being stocked and retrieved. In another example, the RF signaling system may be used in a public transit system to allow passengers to enter and exit the transit system. Healthcare/medical equipment may also be tracked in a hospital or clinical environment using the RF signaling system. Another example is an electronic toll that manages the passage of vehicles at various checkpoints on a highway. Other applications for the present RF signaling system will be readily understood by those skilled in the art.

In some embodiments, the tag 104 comprises one or more sensors, such as temperature sensors, pressure sensors, voltage sensors, humidity sensors, radioactivity sensors, or other sensor type as can be understood by those skilled in the art. The tag 104 may be set to transmit data from one or more of the sensors to the base station 102 regularly, or when activated by the base station 102. A tracking system may also be included in the base station 102 in order to indicate the relative position of the tag 104 with respect to the base station 102. The base station may be fixed or mobile.

Two antennas are present on the base station 102. A first antenna 106a, is set to operate at a first frequency. A second antenna 108a, is set to operate at a second frequency higher than the first frequency. The first antenna 106a is used for emitting a detection signal that will reflect on a target and be sent back to the base station 102 at that same frequency. In one embodiment, the first frequency is 2.45 GHz. The second antenna 108a is used to receive an information signal from the tag 104 and operates at a different frequency. In one embodiment, the second frequency is higher than the first frequency in order to increase the range from which the information signal may be received. The tag 104 comprises corresponding antennas 106b, 108b, which are used to receive the detection signal (106b) and transmit the information signal (108b). In one embodiment, the second frequency is 5.8 GHz.

In an application such as electronic tolls, the base station 102 is fixed while the tag 104 is present in or attached to a moving vehicle. Having the tag 104 transmit at a higher frequency allows the base station 102 to receive the information signal from the tag 104 from a greater distance. Having the base station 102 transmit at a lower frequency is possible because it transmits regularly and can reach the tag 104 when the vehicle is in proximity to the base station 102.

In an application such as the tracking of conditionally-released prisoners, the base station 102 is fixed while the tag 104 is present on the individual, either in a wrist bracelet, an ankle bracelet, or any other means of providing the tag 104 on an individual. The RF signaling system may be used to ensure that the individual stays within a predetermined zone, such as a radius of 100m around the base station 102, or prevents the individual from entering a predetermined zone having the base station 102 therein. The costs associated with the present RF signaling system are significantly less than existing solutions for such an application, such as GPS, GSM, and WiFi. The RF signaling system is also more reliable than calling systems used to verify the presence of an individual in a predetermined zone, such as his or her home.

In an application such as resource management in a warehouse, the base station 102 may be fixed or mobile, within the confines of the warehouse. The tags 104 may be provided on each individual piece of equipment that needs tracking. Similarly to the prisoner application, the RF signaling system is significantly less costly than existing solutions. In addition, the limits of GPS systems inside closed environments are overcome. The system may be used in real-time to signify a breach, and can also have a long life due to the operating conditions, as will be described in more detail below.

FIG. 2 illustrates an exemplary embodiment for the base station 102. A detector 202 is adapted to generate a detection signal at the first frequency and detect the presence of a target when the detection signal is reflected back, via the lower frequency antenna 106a. A decoder 208 is composed of a receiver 204 and a microcontroller 206. The decoder 208 receives the information signal via the higher frequency antenna 108a and decodes it to determine the identity of the target. Detection will establish the presence of an element, such as a vehicle, a package, a person, an animal or other any living thing and/or item that needs to be identified. Identification will provide information concerning the identity of the element.

In an application such as electronic tolls, detection will establish that a vehicle is passing through the toll. If no identification signal is received, this may mean that the vehicle is not authorized to use this particular toll (absence of a tag) and a camera may be used to photograph a license plate in order to identify the driver of the unauthorized vehicle. In the embodiment illustrated in FIG. 2, the base station 102 is equipped to emit and receive signals, as well as detect the presence of an element and determine the identity of that element, if possible. In an alternative embodiment, the base station 102 will simply emit and receive signals and any data analysis or processing will be done remotely.

In the prisoner application, the detector 202 may be set to emit a detection signal at a regular frequency and confirm the presence of the prisoner in the predetermined zone when the signal is reflected back by the lower frequency antenna 106a. The decoder 208 receives the information signal via the higher frequency antenna 108a and decodes it to confirm the identity of the individual. This allows more than one tagged individual to reside in the predetermined zone, and the RF signaling system can distinguish between the tagged individuals. In an embodiment where the tagged individuals having differing conditions of release, a breach of conditions by any one of the individuals can be determined using the information signal with identification information.

In the resource management application, each item in the warehouse may be detected via the detection signal and identified via the information signal. Data regarding the particular conditions of a given item may be stored on the tag 104 and transmitted to the base station 102 via the information signal. For example, if a given piece of equipment requires a minimum of 12 hours to recharge a battery and it is not to be removed from the warehouse until it is fully charge, the information signal may contain the level of charge of the equipment or it may contain the time since it started to charge. If the data indicates that the equipment is not to be removed from the warehouse at the present time, this information may be provided to the individual trying to remove the equipment.

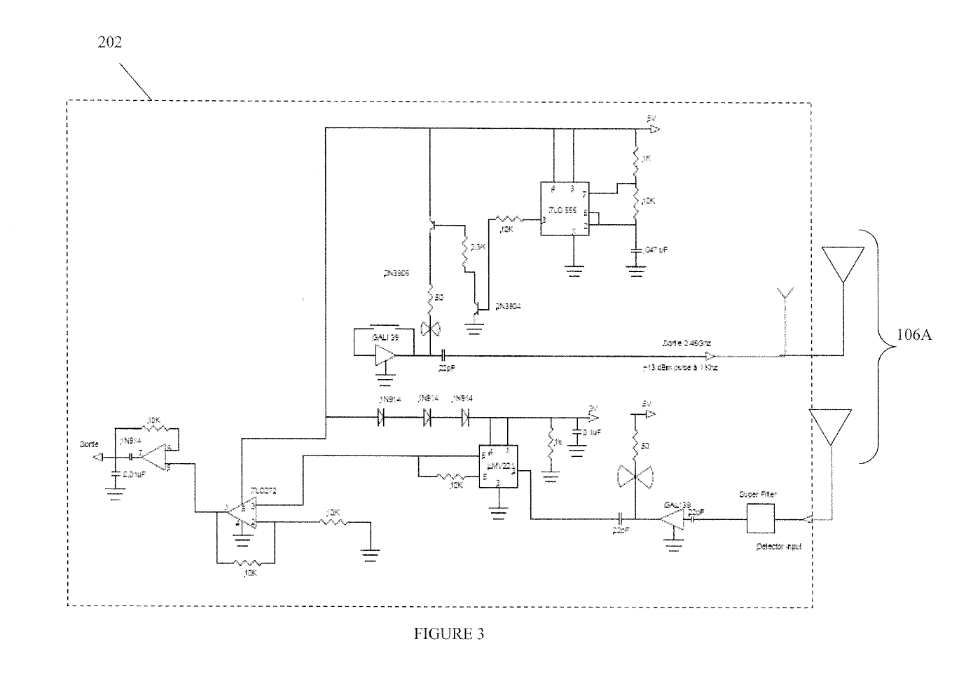

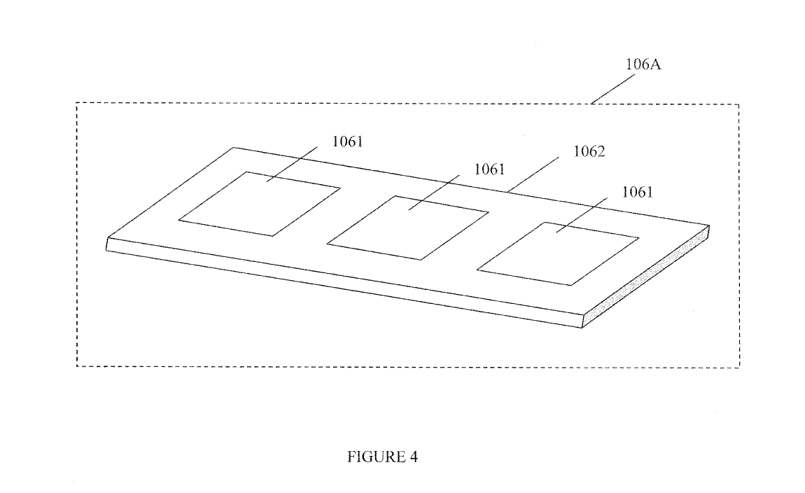

FIG. 3 is an exemplary circuit for the detector 202. In this embodiment, a 2.45 GHz oscillator generates a signal to be emitted by the antenna 106a. The polarization of the oscillator is modulated at low frequency (such as 1 kHz) in order to modulate the detection signal. The reflected signal is received by the antenna 106a connected to an entrance of the detection circuit. In order to reduce interferences, a passive filter limits the incoming bandwidth. A Low Noise Amplifier (LNA) amplifies the received signal and this signal is decoded by a comparator with a threshold set as a function of a desired detection distance. In this embodiment, antenna 106a is composed of two antennas having cross-circular polarization. Two antennas are used in order to increase the isolation between the transmitted signal and the received signal.

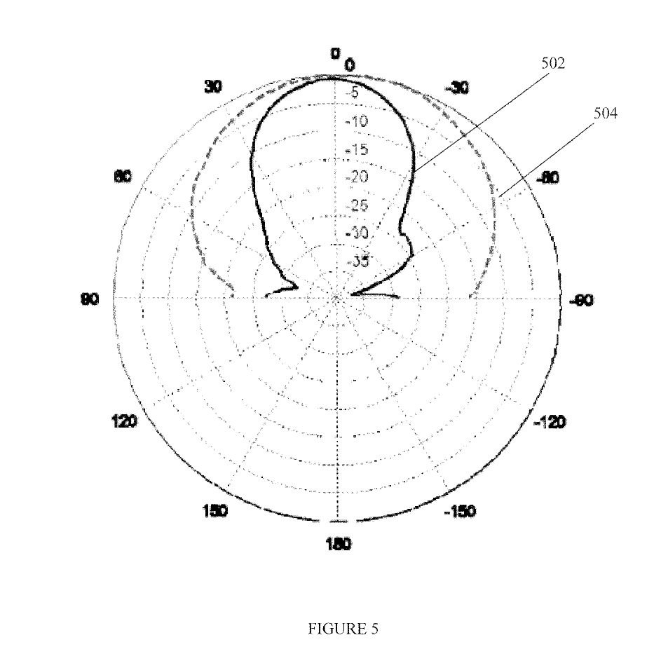

In some embodiments, the antenna 106a may be a narrow beam antenna, such as the one illustrated in FIG. 4. In this case, each antenna 106A is a three patch antenna 1061 network having circular polarization, etched on a substrate 1062 and fed by a slot on the ground plane. The network of antennas is powered by a circuit comprised underneath the patches 1061. The network provides a gain of 10 dBi with a beam having 27° in azimuth and 60° in elevation. Circular polarization is used in order to reduce issues that may arise when the orientation of the tag 104 does not correspond to the orientation of the antenna 106a on the base station 102. The feeding circuit underneath the patch 1061 may be composed of a Wilkinson-type divider with unequal distribution that allows reduction of secondary lobs, as illustrated in the radiation pattern of FIG. 5. The full line 502 refers to azimuth while the dotted line 504 refers to elevation. Various configurations for antenna 106a will be understood by those skilled in the art.

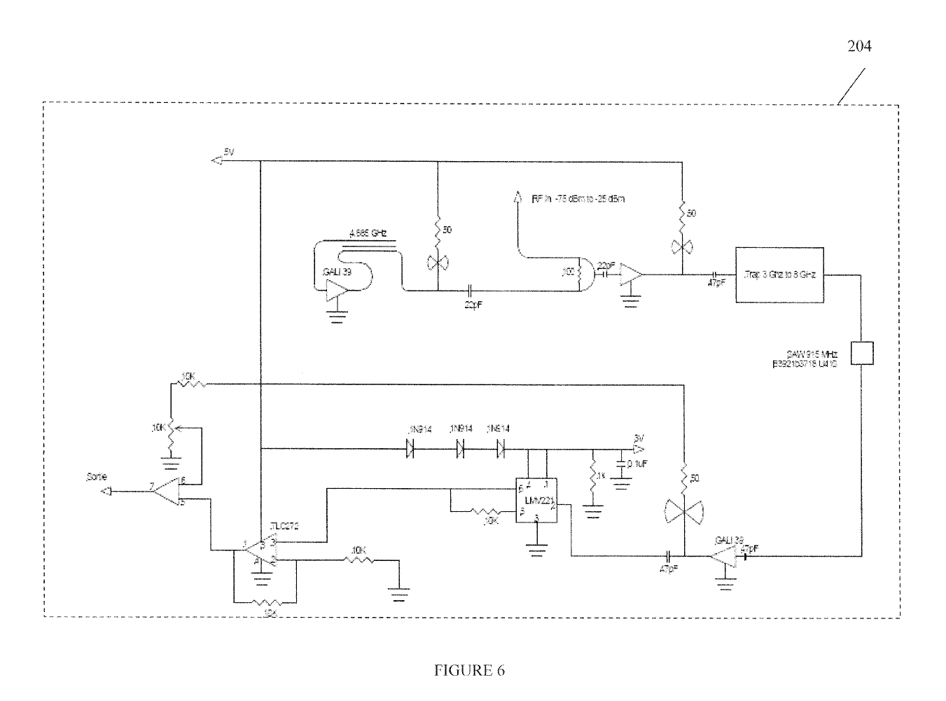

FIG. 6 is an exemplary circuit for an embodiment of the receiver 204. The information signal may be of various forms, such as a word having any given number of bits. In one embodiment, On Off Keying (00K) is used to modulate the signal in order to reduce energy consumption. In the circuit illustrated, the receiver is of a heterodyne type having an intermediate frequency of 915 MHz and a bandwidth of 20 MHz. The local oscillator may be an auto-oscillating circuit composed of a resonator in an amplifier's feedback loop. A mixer is used having an amplifier operating in its non-linear region. This type of mixer generates harmonics that are attenuated by a filter at the output of the amplifier-mixer. The mixer offers a 5 dB gain with respect to the RF input. At the output of the filter, another amplifier increases the signal before introducing it into the detector and sending received data to the microcontroller 206, where the signal will be decoded. The logarithmic detector has a 50 dB dynamic range, thereby offering a detection range between −75 dBm and −25 dBm for this embodiment of the receiver 204.

The microcontroller 206 is used to decode the data transmitted by the tag 104, and also serves to manage communications between the detector 202 and the receiver 204. Decoded data may be sent to a remote computer for further processing. This transmission can be done wirelessly or via a cable connection.

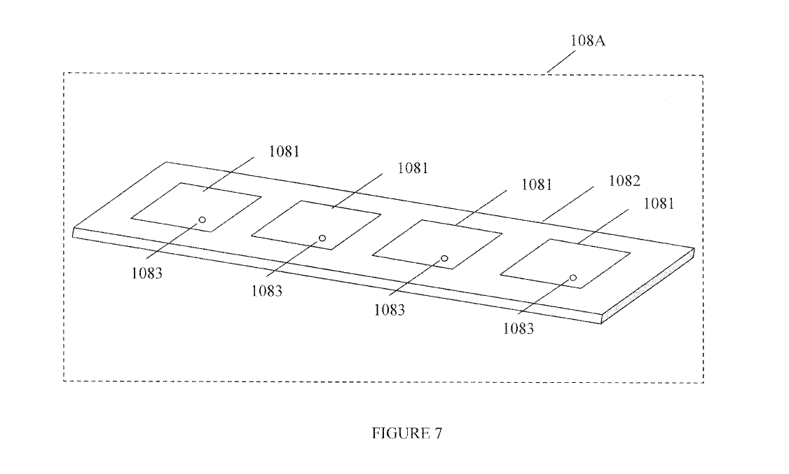

The higher frequency antenna 108a may be of various configurations. In one embodiment, the antenna 108a may be a network of four patch antenna 1081 etched on a substrate 1082 and fed by a via 1083 on one corner to obtain a circular polarization, as illustrated in FIG. 7. Similarly to the antenna illustrated in FIG. 4, the power source may be a Wilkinson divider with uneven distribution underneath the patch. The radiation pattern for this embodiment is illustrated in FIG. 8, with the azimuth represented by the full line 802 and the elevation represented by the dotted line 804. This narrow beam antenna having four elements provides a 12 dBi gain with a beam-width of 20° in azimuth and 50° in elevation. This embodiment is suitable for an electronic toll application.

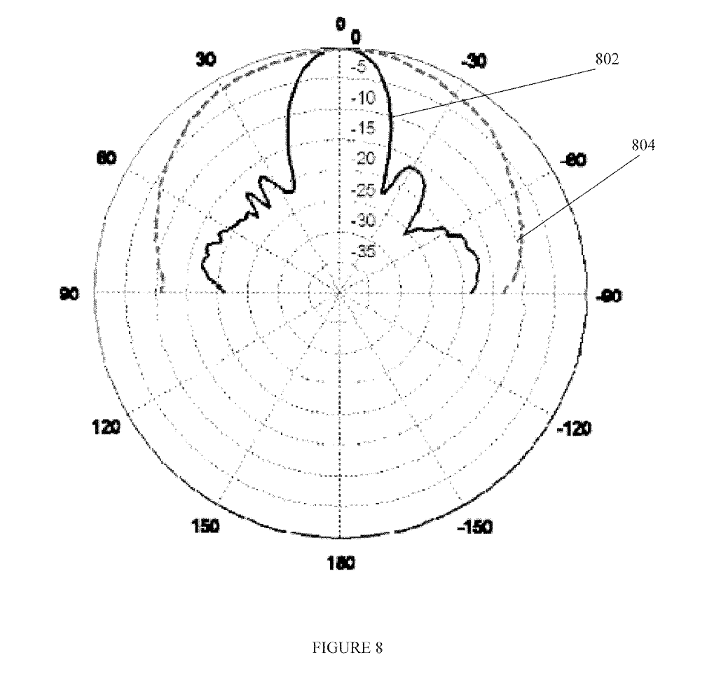

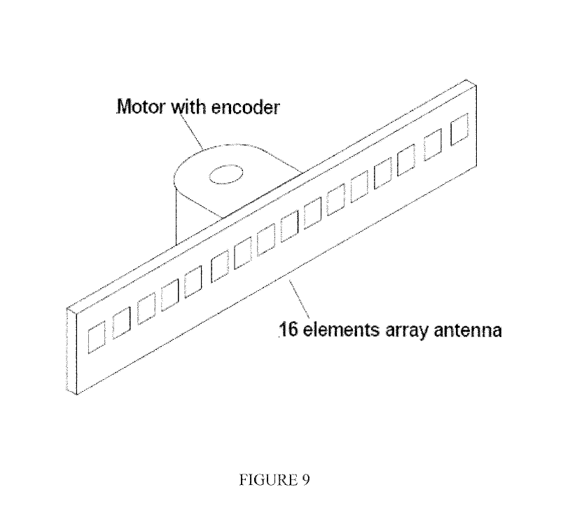

In a tracking application, an embodiment such as the one illustrated in FIG. 9 may be employed. In this case, a network having 16 elements may be mounted on a pivoting device in order to allow the antenna to cover a broader area. The gain and coverage of this antenna is superior to that provided by the embodiment of FIG. 7. In some embodiments, two such antennas may be provided in a given area, at opposite positions, and an angle is recorded when a tag signal is received. It is then possible to locate the position of the tag in a room having up to 100 meters by 100 meters of surface area. The antennas may have circular polarization in order to avoid a rupture in the communication, in the case where the tag antenna has a linear polarization.

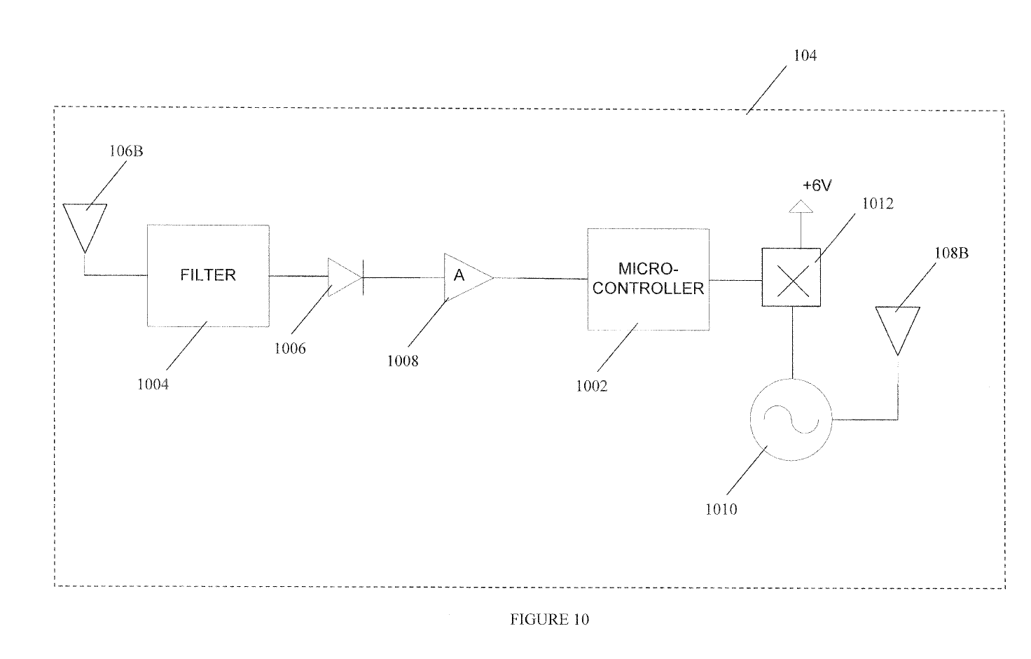

FIG. 10 illustrates one embodiment for the tag 104. The receiving antenna 106b operates at the first frequency while the transmitting antenna 108b operates at the second and higher frequency. The tag 104 is bidirectional and can therefore receive and send data. Its ability to receive at one frequency while sending at a second frequency allows flexibility in terms of range for receiving and sending data. A longer distance is attainable for transmitting data.

In one embodiment, the tag 104 is activated when it receives a 1 kHz square wave. The tag 104 will then transmit its identification data on an information signal, such as for example in a 32 bit word. A communication protocol, such as those defined in the RFID norms, may be used between the base station 102 and the tag 104 to set the tag 104 to various modes, such as in a continuous transmission mode, with multiple repetition rates, etc. Other data, in addition to or instead of the identification data, may also be provided on the information signal.

In some embodiments, the tag 104 can be programmed to operate only in transmit mode by the detection signal sent from the detector 202. The 1 KHz signal can be modulated and transmit information by antenna 106A to tag 104, and microcontroller 1002 can decode this information to set the tag to transmit mode only. In transmit mode, the tag 104 may send its identification code in a continuous manner at a regular time interval. The time can be chosen from one millisecond to 100000 seconds. In this mode, it is possible to follow the position of tag 104 using the scanning antenna from FIG. 9. The transmit mode can be use to send sensor information from tag 104 when an integrated sensor is present.

In the embodiment illustrated in FIG. 10, the minimum time required to detect the detection signal from the base station 102 is three clock cycles of the 1 kHz detection signal at 2.45 GHz. To transmit the information signal, one exemplary protocol is as follows. Each clock cycle is 100 μs long. A <0> corresponds to a high state of 50 μs followed by a low state of 50 μs. A <1> corresponds to a high state of 75 μs followed by a low state of 25 μs.

In some embodiments, the tag 104 comprises a microcontroller 1002 that remains dormant until awakened by a received detection signal. This microcontroller 1002 may have an internal memory for storing data, such as ID data, sensor data, etc. The memory may be increased for certain applications.

In one embodiment, antenna 106b may be a Planar Inverted F Antenna (PIFA) directly printed on the printed circuit of the tag 104. A SAW, a ceramic, or any other type of filter 1004 may be used to select the receive band, and a diode 1006 (for example Schottky, GaAs, etc) detects the modulation signal at 1 KHz sent from the base station 102. At the output, an amplifier 1008 (such as a low frequency amplifier) amplifies the detected signal before sending it to the microcontroller 1002. The tag receiver's sensitivity is approximately −45 dBm. This sensitivity may vary, depending on the circuit.

In the embodiment illustrated in FIG. 10, the circuit comprises an auto-oscillating circuit 1010 that generates a 5.8 GHz signal. Modulation is provided, in an On-Off mode, by a modulator 1012 (such as a transistor) that feeds the oscillator 1010.

The oscillator 1010 for generating the 5.8 GHz signal in the tag 104 and/or in the base station 102 may be fabricated using various types of substrates. One embodiment for the substrate will be described in detail herewith.

A typical thermal expansion parameter of a microwave substrate is between 10 to 20 ppm/° C. This means that if a resonator having a resonance frequency of 5.8 GHz is designed on a substrate with a dielectric constant of 3.48, the length will be 0.612 inches at 5.800 GHz. For a variation range of −20 to 60° C., i.e. 80° C., this results in 1200 ppm for a variation having a length of 0.0008 inches. This can shift the frequency to 5.785 GHz, which could be outside the band of the receiver.

Another parameter that affects the behavior of the oscillator is the dielectric constant's variation with respect to temperature. Resonant circuits are sensitive to the electrical length, which is a function of the dielectric constant. For a typical substrate having a coefficient of +50 ppm/° C., and having a thermal variation of 80° C., its dielectric constant will be 3.495 instead of 3.48. Therefore, a resonator designed for 5.8000 GHz will actually be at 5.788 GHz, i.e. 12 MHz lower.

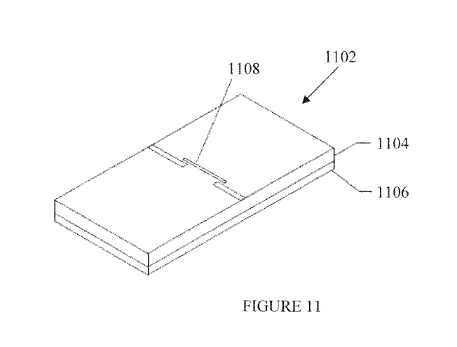

FIG. 11 illustrates an exemplary resonator 1102 formed of two substrates 1104 and 1106 and a half wave microstrip resonator 1108. A first substrate 1104 having a positive thermal coefficient of the dielectric constant is combined with a second substrate 1106 having a negative thermal coefficient of the dielectric constant in order to counter the effect of the thermal variation. The thermal expansion effect is compensated by the dielectric constant's variation of the two substrates with coefficients of opposite signs. This provides additional thermal stability to the substrate, and by extension, the resonator.

In order to obtain the desired ratio, in addition to the signs of the two substrates 1104, 1106, the relative thickness of one substrate 1104 with respect to the other substrate 1106 may be selected. FIGS. 12a and 12b illustrate the thermal response of two exemplary oscillators made on two different substrates, one having a positive thermal coefficient of dielectric constant (FIG. 12a) and the other having a negative thermal coefficient of dielectric constant (FIG. 12b). Any positive and any negative curve may be chosen. The relative thicknesses of the two substrates 1104, 1106 are then adjusted such that the thermal variations cancel each other out. The resulting slope of the combined substrates will cancel variations in thermal expansion and/or variations in temperature of the components, depending on the application.

The effective coefficient can then be determined, and used when designing and/or fabricating the oscillator. Alternatively, the thickness of the materials may be selected first, and the material itself is then selected as a function of its thermal coefficient of εᵣ to obtain a resultant substrate having a compensated thermal variation effect.

In some embodiments, more than two materials may be used to compensate for the thermal variations, by selecting appropriate thicknesses for each substrate. Alternatively, more than one layer of a given material may be used. Also alternatively, a single substrate may be created by mixing two or more materials together in order to create a single stable substrate.

When using two or more layers of two or more materials to create a substrate, the layers may be attached using various techniques, such as glue, adhesives, and other attachment means. For this particular application, the adhesive thickness should be very small, such as in the range of microns, to take advantage of the thermal coefficient of each layer. To reduce the adhesive thickness, the material may be pressed at a very high pressure with thermal heating during the curing process of the adhesive.

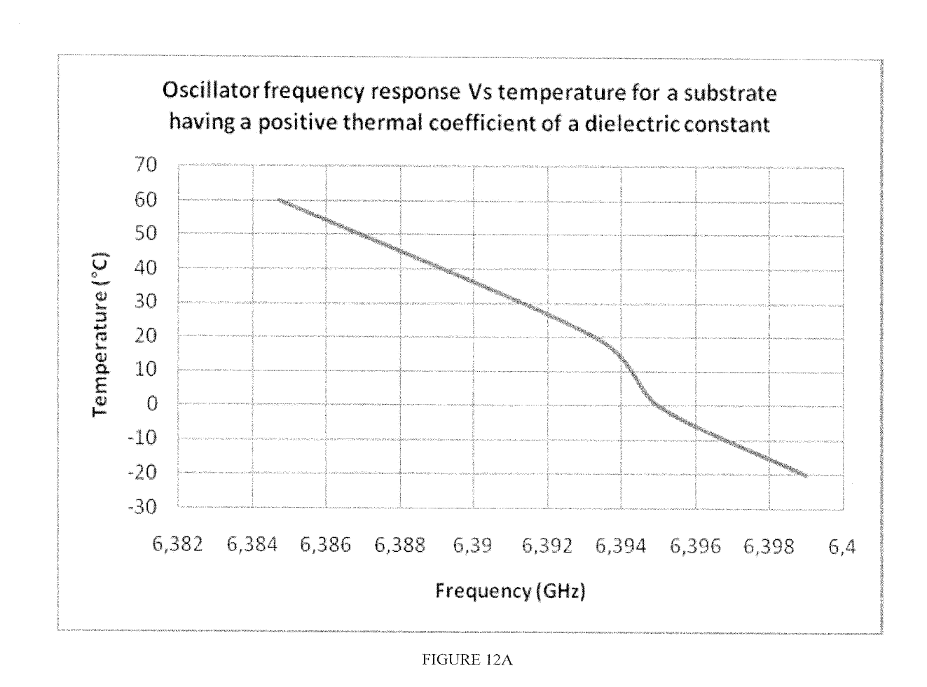

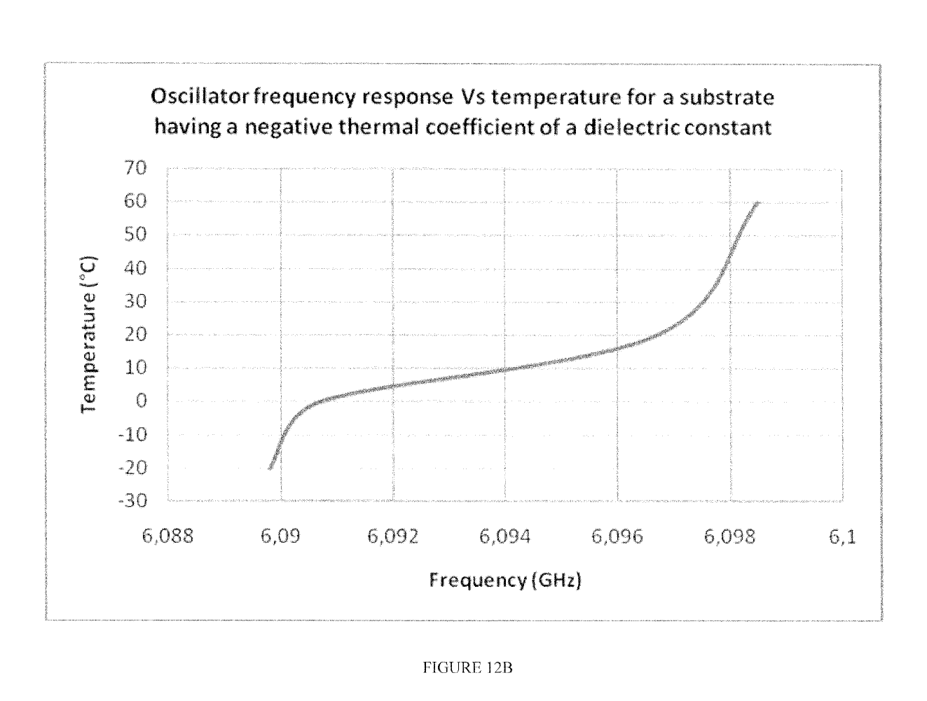

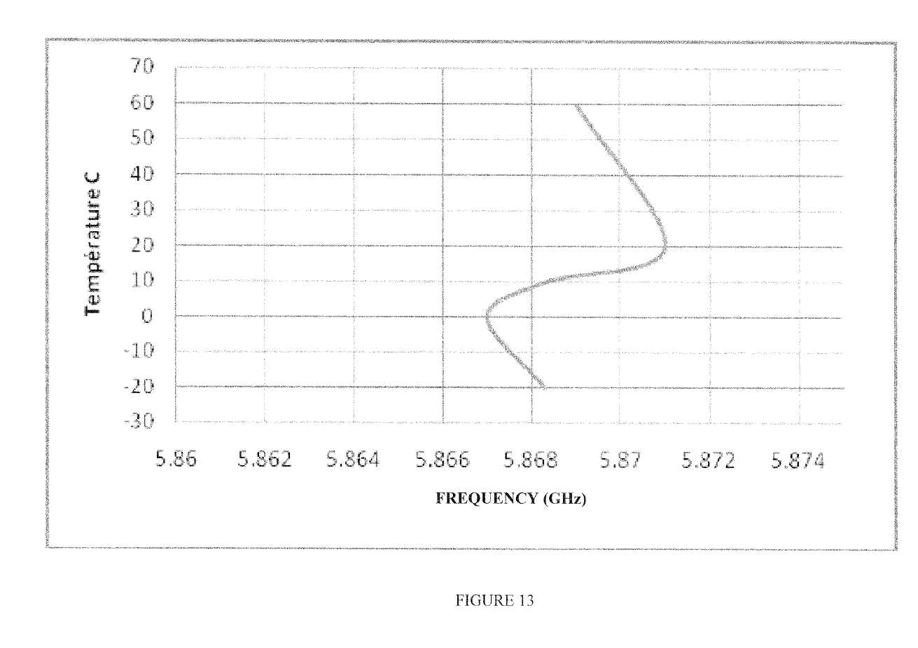

FIG. 13 illustrates a frequency vs. temperature curve of an oscillator made of a substrate created from a bottom layer having a thickness of 10 mil and a top layer having a thickness of 13.6 mil. The corresponding thermal coefficients of εᵣ values are −160 and +40 respectively. For a range in temperature from −20 to 60° C., the resulting variation in frequency is less than 8 ppm.

The described substrate has increased thermal stability and may be used for various applications, such as any radio frequency application having transmission lines requiring temperature stability. Any technology capable of making transmission lines may be used, such as Microstrip, Microstrip with superstrate, Grounded Coplanar Waveguide, Grounded Coplanar Waveguide with superstrate, Substrate Integrated Waveguide, Slotline, Slotline with superstrate, Stripline, Dielectric Loaded Waveguide, etc. The substrate may be used for various RF applications, such as for passive components, antennas, RFID systems/sub-systems, and testing and measuring systems. The substrate may also be used in filters, oscillators, resonators, narrow bandwidth antennas, etc.

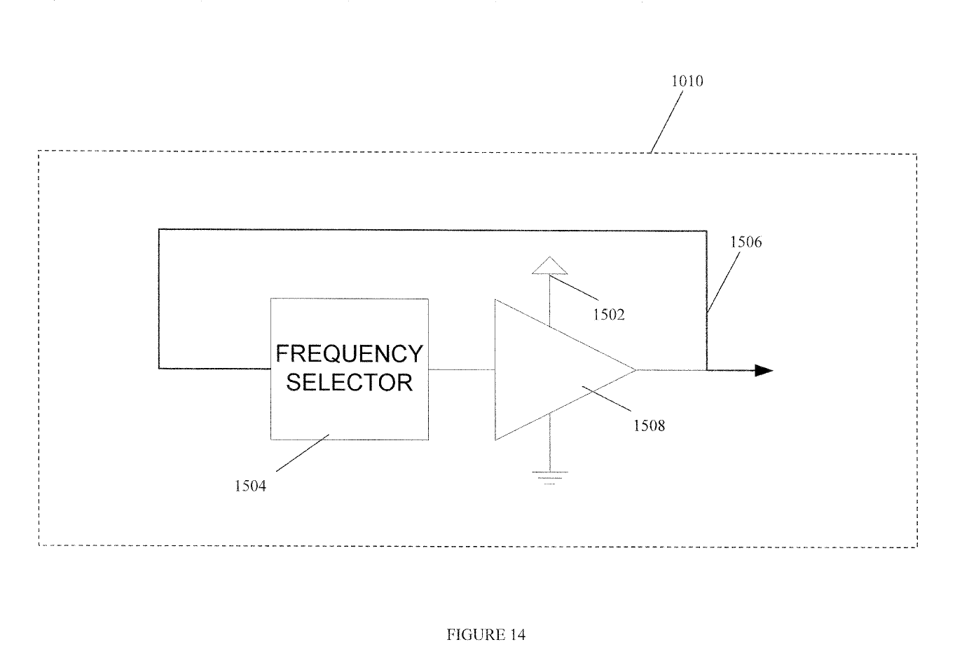

It will be understood that an oscillator 1010 comprising the described substrate will also consist of at least the basic elements of any oscillator, namely a power source 1502, a frequency determining circuit 1504, a positive-feedback circuit 1506, and an amplifying element 1508. An exemplary circuit of a generic nature is illustrated in FIG. 14. In some embodiments, the frequency determining circuit 1504 will be a single element and/or the positive-feedback circuit 1506 will be a single device. For example, the power source 1502 may be one or more direct-current power supplies, the frequency determining circuit 1504 may be an RC circuit, the positive-feedback circuit 1506 may be a feedback path from an amplifier, and the amplifying element 1508 may be an amplifier with a saturation behavior that sets the amplitude of oscillation at the output to ±Vₘₐₓ. Alternative embodiments for these elements will be readily understood by the person skilled in the art.

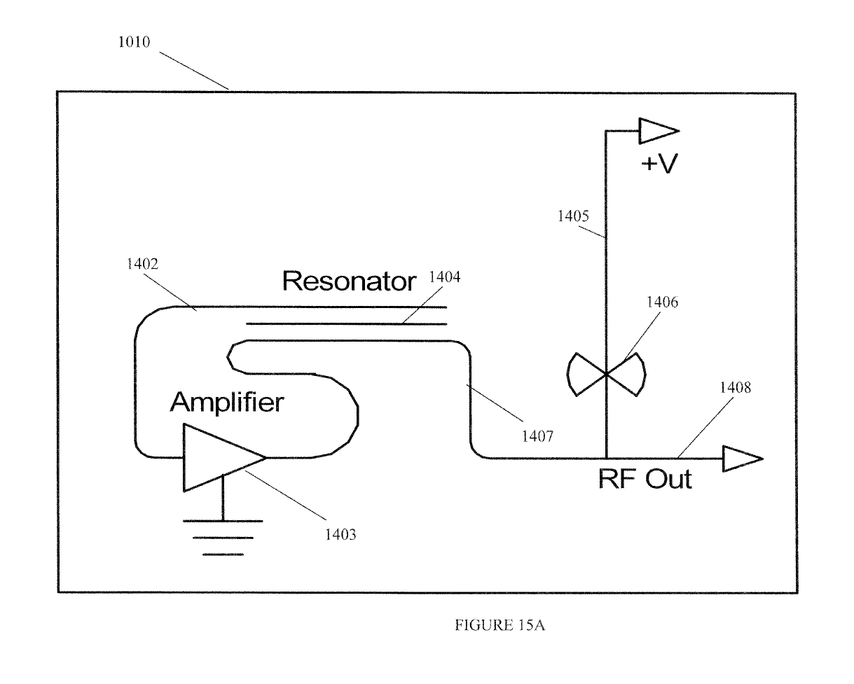

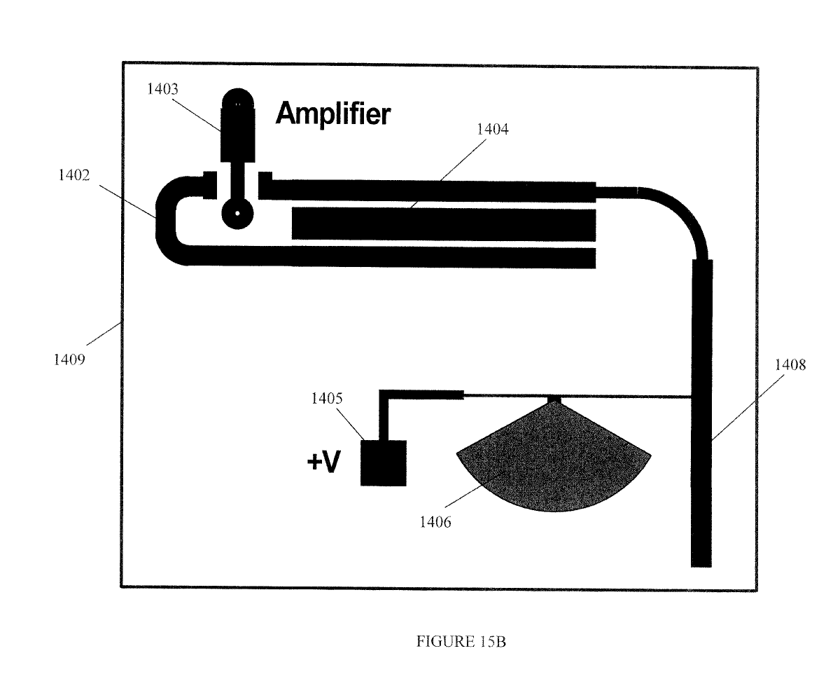

FIG. 15a is another exemplary circuit diagram of an oscillator 1010. FIG. 15b shows its realization on the substrate 1409 made of two substrates layer to compensate the thermal effects. This oscillator 1010 consists of a half wave resonator 1404 in the feedback loop 1402 of an amplifier 1403. The portion of the signal going out of the loop 1402 to the output 1408 and the portion of the signal kept in the loop 1402 are adjusted by a mismatch. The amplifier 1403 is biased by the direct courant input 1405, connected to the radiofrequency circuit by a bias line at the connection 1407, and isolated from the radiofrequency circuit thanks to the distributed capacitor 1406. These circuits are only for illustration purposes and should be considered exemplary in nature.

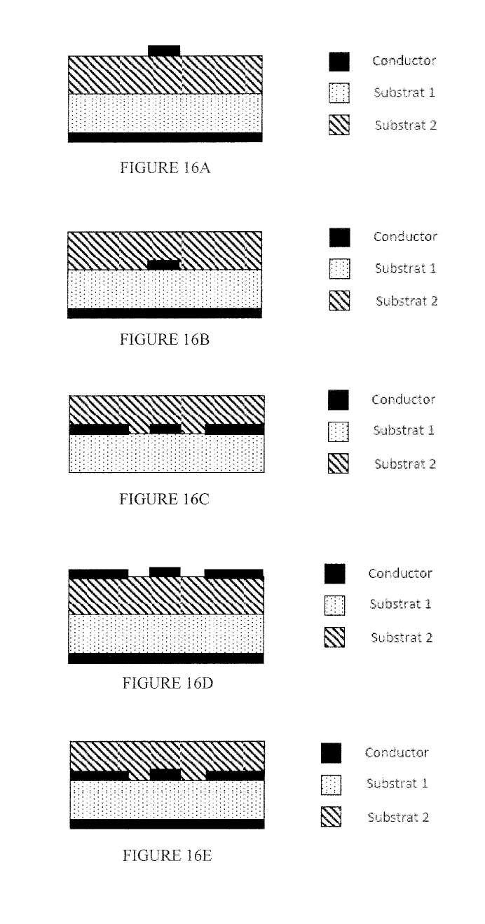

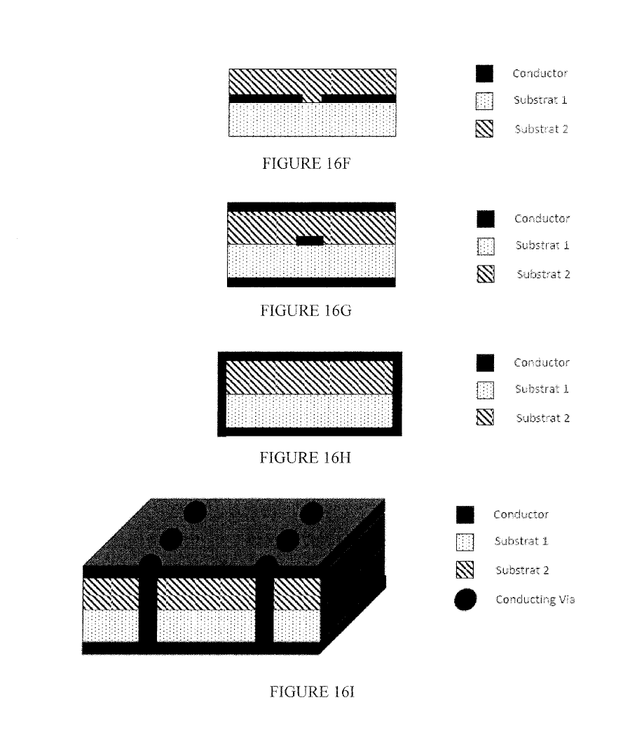

FIGS. 16a-16i illustrate various embodiments of transmission lines for compensation of thermal effects, as per the above description. For all of the illustrated embodiments, the thermal expansion effect is compensated by the dielectric constant's variation of the two substrates with coefficients of opposite signs. This provides additional thermal stability to the transmission line.

FIG. 16a illustrates a Microstrip transmission line made of two substrates for compensation of thermal effects. A first substrate having a positive thermal coefficient of the dielectric constant is combined with a second substrate having a negative thermal coefficient of the dielectric constant in order to counter the effect of the thermal variation. Conductors are placed above and below the two substrates

FIG. 16b illustrates a Microstrip transmission line with a substrate and a superstrate for compensation of thermal effects. A substrate having a positive (or negative) thermal coefficient of the dielectric constant is located in-between the two conductors. A superstrate having a negative (or positive) thermal coefficient of the dielectric constant is placed above the top conductor in order to counter the effect of the thermal variation.

FIG. 16c illustrates a Coplanar Waveguide transmission line with a substrate and a superstrate for compensation of thermal effects. A substrate having a positive (or negative) thermal coefficient of the dielectric constant is located under the conductors. A superstrate having a negative (or positive) thermal coefficient of the dielectric constant is placed above the top conductor in order to counter the effect of the thermal variation.

FIG. 16d illustrates a Grounded Coplanar transmission line made of two substrates for compensation of thermal effects. A first substrate having a positive thermal coefficient of the dielectric constant is combined with a second substrate having a negative thermal coefficient of the dielectric constant in order to counter the effect of the thermal variation. The two substrates are provided between conductors.

FIG. 16e illustrates a Grounded Coplanar Waveguide transmission line with a substrate and a superstrate for compensation of thermal effects. A substrate having a positive (or negative) thermal coefficient of the dielectric constant is located in-between the conductors. A superstrate substrate having a negative (or positive) thermal coefficient of the dielectric constant is placed above the top conductor in order to counter the effect of the thermal variation.

FIG. 16f illustrates a Slotline transmission line with a substrate and a superstrate for compensation of thermal effects. A substrate having a positive (or negative) thermal coefficient of the dielectric constant is located under the conductors. A superstrate having a negative (or positive) thermal coefficient of the dielectric constant is placed above the top conductor in order to counter the effect of the thermal variation.

FIG. 16g illustrates a Stripline transmission line made of two substrates for compensation of thermal effects. A first substrate having a positive (or negative) thermal coefficient of the dielectric constant is located under the central conductor. A second substrate having a negative (or positive) thermal coefficient of the dielectric constant is placed above the central conductor in order to counter the effect of the thermal variation. A bottom conductor is also provided beneath the first substrate.

FIG. 16h illustrates a Dielectric Loaded Waveguide transmission line made of two substrates for compensation of thermal effects A first substrate having a positive (or negative) thermal coefficient of the dielectric constant is combined with a second substrate having a negative (or positive) thermal coefficient of the dielectric constant in order to counter the effect of the thermal variation. A conductor surrounds the two substrates.

FIG. 16i illustrates a Substrate Integrated Waveguide transmission line made of a top and bottom conductor connected with conducting via and of two substrates for compensation of thermal effects. A first substrate having a positive (or negative) thermal coefficient of the dielectric constant is combined with a second substrate having a negative (or positive) thermal coefficient of the dielectric constant in order to counter the effect of the thermal variation.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

The embodiments of the invention described above are intended to be exemplary only. The scope of the invention is therefore intended to be limited solely by the scope of the appended claims.

1. An active bidirectional tag for use with a base station in a Radio Frequency signaling system, the tag comprising:
at least a first antenna for receiving a detection signal emitted from the base station at a first frequency;
a control circuit for storing identification data and providing the identification data on an information signal when activated by the detection signal; and
at least a second antenna adapted for transmitting the information signal at a second frequency to the base station.

2. The tag of claim 1, wherein the first frequency is lower than the second frequency.

3. The tag of claim 1, further comprising at least one sensor selected from the group of temperature, pressure, voltage, humidity, and radioactivity.

4. The tag of claim 3, wherein the control circuit is adapted to provide information from the at least one sensor on the information signal.

5. The tag of claim 1, wherein the information signal as a multi-bit word.

6. The tag of claim 1, wherein the control circuit comprises an oscillating circuit.

7. The tag of claim 6, wherein the oscillating circuit comprises a substrate having at least two layers, one of the at least two layers having a positive thermal coefficient of a dielectric constant and another of the at least two layers having a negative thermal coefficient of a dielectric constant.

8. The tag of claim 7, wherein the at least two layers are superposed on top of each other.

9. The tag of claim 8, wherein a conductive material is placed in between the at least two layers, one of the at least two layers acting as a superstrate while the other of the at least two layers acting as a substrate.

10. The tag of claim 7, wherein a relative thickness of the at least two layers results in a cancellation of thermal variation effects of the substrate.

11. The tag of claim 7, wherein a combination of the positive thermal coefficient of a dielectric constant and the negative thermal coefficient of a dielectric constant results in a cancellation of thermal variation effects of the substrate.

12. The tag of claim 7, wherein at least one of the at least two layers is composed of at least two materials.

13. The tag of claim 1, wherein any one of the first antenna and the second antenna comprises a patch antenna network having circular polarization.

14. The tag of claim 1, wherein the control circuit is programmable using the detection signal to cause the tag to operate in one of a plurality of modes.

15. The tag of claim 14, wherein the modes are selected from a group comprising send and receive, transmit only, sensor, and any combination thereof.

16. An RF signaling system comprising a tag in accordance with claim 1, and a base station having at least a third antenna and a fourth antenna, the third antenna adapted for transmission of the detection signal at the first frequency and reception of a reflection of the detection signal at the first frequency, the fourth antenna adapted for reception of the information signal at the second frequency.

17. The system of claim 16, wherein the base station further comprises a detection circuit for generating the detection signal at the first frequency and detecting a presence of a target when receiving the reflection of the detection signal.

18. The system of claim 16, wherein the base station further comprises a decoding circuit for extracting data from the information signal.

19. The system of claim 16, wherein at least one of the first antenna and the second antenna is rotatably mounted on the base station for rotation thereof in order to scan an area.

20. A Radio Frequency signaling system comprising:
a base station having at least a first antenna and a second antenna, the first antenna adapted for transmission of a detection signal at a first frequency and reception of a reflection of the detection signal at the first frequency, the second antenna adapted for reception of an information signal at a second frequency; and
an active, bidirectional tag having at least a third antenna and a fourth antenna, the third antenna adapted for receiving the detection signal at the first frequency, the fourth antenna adapted for transmitting the information signal at the second frequency.
